(19) United States
(12) Patent Application Publication
(10) Pub. No.: US 2016/0300190 A1
(43) Pub. Date: Oct. 13, 2016

(54) PERFORMANCE EVALUATION SYSTEM

(71) Applicant: Chequed.com, Inc., Saratoga Springs, NY (US)

(72) Inventor: Gregory C. Moran, Ballston Spa, NY (US)

(21) Appl. No.: 14/681,600

(22) Filed: Apr. 8, 2015

(51) Int. Cl. G06Q 10/10; H04L 12/26; G06Q 10/06; H04L 29/08

(52) U.S. Cl. CPC G06Q 10/1053; H04L 67/10; H04L 43/0817; H04L 43/04; G06Q 10/06398

(57) ABSTRACT

A system, method and program product are provided for evaluating resource selection efforts. The disclosed system includes: computing platform for evaluating performance of nodes external to a subscribing system, comprising: a system for capturing metadata associated with a new resource in response to the new resource being introduced into the subscribing system from an external node, wherein the metadata includes details about the external node and the new resource; a system for interrogating a plurality of stakeholder nodes in the subscribing system regarding interactions with the new resource after a predetermined evaluation period has ended; and a system for analyzing response data from the plurality of system nodes, wherein an analysis of the response data provides a measured performance of the external node.

### TECHNICAL FIELD

The subject matter of this invention relates generally to a system and method that quantifies and improves performance of a resource selection process.

### BACKGROUND

In any system, it is important to be able to effectively evaluate performance of particular processes or nodes of the system. Based on the performance of a given process, changes or improvement can be made to increase efficacy of the entire system. One of the challenges of evaluating performance of different processes of a system is that there may not be mechanisms for effectively collecting information from a particular process.

For example, the impact of a process for selecting and introducing external resources into a system may not be easily measured or readily understood. Often, the impact of the selection process may be clouded by factors such as time and the behavior or performance of other system nodes, which interact with a newly introduced resource. Often, it is difficult to discern whether the successful importation of a new resource is a result of a well tuned selection process, random chance, or actions of other system nodes.

Accordingly, new methods and systems for evaluating and improving resource selection processes in a system are needed.

### SUMMARY

In general, aspects of the present invention provide a solution for assessing and improving a resource selection process that selects external resources for importation into a system. Aspects also include quantifying upstream performance of external nodes based on interrogations from downstream nodes within a system.

A first aspect of the invention provides computing platform for evaluating performance of nodes external to a subscribing system, comprising: a system for capturing metadata associated with a new resource in response to the new resource being introduced into the subscribing system from an external node, wherein the metadata includes details about the external node and the new resource; a system for interrogating a plurality of stakeholder nodes in the subscribing system regarding interactions with the new resource after a predetermined evaluation period has ended; and a system for analyzing response data from the plurality of stakeholder nodes, wherein an analysis of the response data is used to calculate a measured performance of the external node.

A second aspect of the invention provides a computer program product stored on computer readable medium, which when executed by a computer system, evaluates performance of a resource selection process in a subscribing system, comprising: program code for inputting metadata into a knowledge base for a new resource and assigning an evaluation period for the new resource; program code for automatically distributing inquiries to stakeholder nodes after completion of the evaluation period via a network and collecting results via the network; program code that evaluates the results and assigns a performance measure to the resource selection process associated with the new resource; program code that statistically analyzes resource selection data of a plurality of new resources and generates a resource selection assessment; and program code for outputting at least one of the performance measure and the resource selection assessment in response to an inputted requirement.

A third aspect of the invention provides a computerized method of evaluating performance of a resource selection process in a subscribing system, comprising: inputting metadata for a new resource into a knowledge base in response to the new resource being introduced into the subscribing system and assigning an evaluation period for the new resource; automatically distributing inquiries after completion of the evaluation period via a network to a set of stakeholder nodes and collecting results via the network; evaluating the results and assigning a performance measure to the resource selection process associated with the new resource; statistically analyzing resource selection data of a plurality of new resources and generating a resource selection assessment; and outputting at least one of the performance measure and the resource selection assessment in response to an inputted requirement.

A fourth aspect of the invention provides a system for evaluating recruitment efforts, comprising: a system for inputting recruitment data for a new hire data into a knowledge base and assigning an evaluation period for the new hire; a system for automatically distributing questionnaires comprising survey questions after completion of the evaluation period via a network to a set of stakeholders and collecting survey results via the network; a scoring system that evaluates the survey results and assigns a recruitment score to a recruitment effort associated with the new hire; an analysis system that statistically analyzes recruitment data of a plurality of new hires and generates a recruitment effort assessment; and a reporting system for outputting at least one of the recruitment score and the recruitment effort assessment in response to an inputted requirement.

### BRIEF DESCRIPTION OF THE DRAWINGS

These and other features of this invention will be more readily understood from the following detailed description of the various aspects of the invention taken in conjunction with the accompanying drawings in which:

FIG. 1 shows an evaluation platform for assessing a resource selection process in a subscribing system according to embodiments of the invention.

FIG. 2 shows a computer system having a recruitment evaluation system according to embodiments of the invention.

FIG. 3A shows a new hire report according to embodiments of the invention.

FIG. 3B shows a dashboard report according to embodiments of the invention.

FIG. 4 shows an analysis report according to embodiments of the invention.

FIG. 5 shows a flow diagram of a method for implementing a recruitment evaluation system according to embodiments of the invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

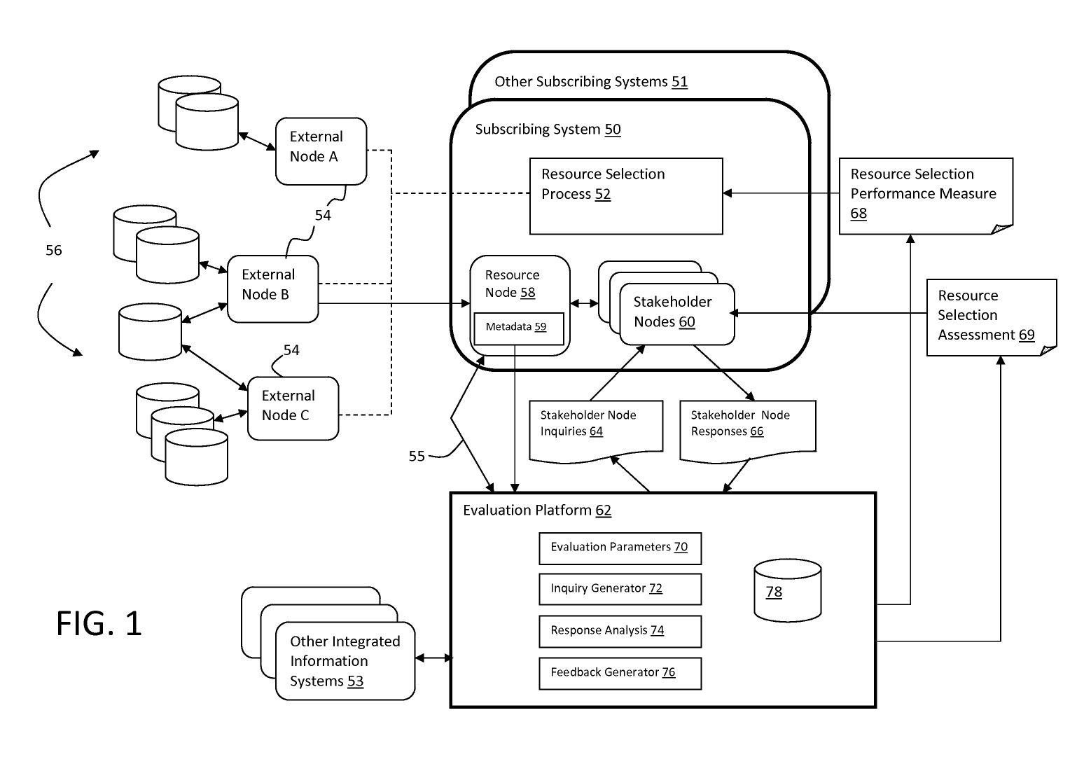

FIG. 1 depicts a generalized overview of an evaluation platform 62 that evaluates the resource selection process 52 of a participating or “subscribing” systems 50, 51. In particular, evaluation platform 62 provides performance metrics including (a) a resource selection performance measure 68 for the resource selection process 52 fora new resource node 58 being introduced into subscribing system 50 by an external node 54, and (b) a resource selection assessment 69 that provides a comprehensive, comparative and statistical analysis of the resource selection process, e.g., over time or relative to other selections.

Subscribing system 50 may comprise any, type of entity, enterprise, device, etc., equipped to import resource nodes 58 to further the operation of the subscribing system 50. For example, subscribing system 50 may comprise a computing platform that loads external resources 56, e.g., memory, data, computational functions, human resource data, etc., from a cloud infrastructure, via external nodes 54. External nodes 54 may for example comprise cloud orchestrators or brokers, which may use automated, semi-automated or manual processes.

Subscribing system 50 generally includes a set of stakeholder nodes 60 for implementing processes and actions within the subscribing system 50. From time to time, subscribing system 50 may require additional resources to fulfill its objectives. To handle this, a resource selection process 52 is utilized to interface with external nodes 54 (A, B and C), which in turn have access to external resources 56. Resource selection process 52 may utilize any criteria for selecting an external node 54 and or external resource 56, e.g., cost, availability, requirements, past performances, etc. Regardless, once an external node 54/resource 56 is chosen to fulfill the need of the subscribing system 50, it is imported into the subscribing system 50 (e.g., resource node 58).

As shown, whenever a resource node 58 is loaded into subscribing system 50, associated metadata 59 is likewise captured that further describes or categorizes the resource node 58 and the supplying external node 54, e.g., ID, type, origination details, age, capabilities, past performances, etc.

While it is relatively straightforward for subscribing system 50 to evaluate the performance of the resource node 58 once it is incorporated into subscribing system 50, it is much more challenging to evaluate the perfoxxnance of the resource selection process 52, as well as the external nodes 54, in a comprehensive manner. For example, how do you determine whether a successful installation of a resource node 58 was the result of the resource selection process 52, actions of the stakeholder nodes 60, random chance, etc.

To address this, evaluation platform 62 kicks off various processes in response to a new resource node 58 being incorporated into subscribing system 50. Initially, metadata 50 associated with the resource node 58 is loaded into a knowledge base 78. After an evaluation period ends, the evaluation platform interrogates stakeholder nodes 60 to ascertain the performance of the new resource node 58. Stakeholder nodes 60 may comprise any device, process, entity, system, resource, etc., that interact with the resource node 58. Based on the interrogation, a set of performance metrics 68 are calculated and fed back into resource selection process 52 in order to time tune the selection process going forward. This process has the added benefit of evaluating the new resource node 58 to determine if it is failing to meet its performance requirements.

Evaluation platform 62 utilizes various processes to generate performance metrics 68. A first process includes a mechanism for setting evaluation parameters 70, including the evaluation period. Often, it can many months before a new resource node 58 is evaluated to determine whether it is meeting its objectives. The present approach seeks to perform the evaluation as soon as possible, e.g., within 30-180 days after the resource node 58 has been incorporated into system 50. Early evaluation provides a better assessment of how well the external node 54 performed, e.g., how easily was the resource node 58 assimilated into the subscribing system 50, how quickly was it able to perform its objective, etc. Such information may be lost over time as system requirements change, modifications are made, workarounds are introduced, etc.

Inquiry generator 72 generates a set of inquiries 64 targeted at stakeholder nodes 60. Stakeholder node inquiries 64 may include anything that assesses the performance of resource node 58, and more particularly, how successful is resource node 58 fulfilling its objectives, e.g., what is the error rate, how did the installation process go, how much intervention was required before resource node 58 was fully operational, etc. Stakeholder nodes 60 may include any type of device, process, human resource, etc., capable of receiving an inquiry and generating a response in an automated, semi-automated or manual fashion. A similar process 55 may be directed at the resource node 58 itself.

Stakeholder node responses 66 are collected by evaluation platform 62 and a response analysis system 74 analyzes the responses to ascertain how well external nodes 54 performed. Performance may be comprehensive and comparative in nature, e.g., external nodes 54 may be ranked based on how well each performed in delivering a particular category of resource. As shown, evaluation platform 62 may be implemented as a SaaS (Software as a Service) model in which any number of other subscribing systems 51 also participate and share performance information for analysis. Regardless, feedback generator 76 packages the analysis results, i.e., performance metrics 68 that can be utilized by resource selection process 52. Other data, e.g., from other integrated information systems 53 may be utilized to enhance analysis results.

In one illustrative embodiment, system 50 may comprise a computing platform that utilizes cloud resources. In such an embodiment, resource node 58 may for example comprise allocated memory, and system nodes 60 may comprise computing elements that utilize or interface with the allocated memory. Resource selection process 52 may utilize an automated process to interface with a set of cloud orchestrators (external nodes 54) to identify the best option for the memory requirements. Shortly after the memory is installed, i.e., made available to system 50, metadata 59 is collected and after an evaluation period, evaluation platform 62 sends out stakeholder node inquiries 64, e.g., agents, that automatically interrogate various stakeholder nodes 60 to determine the initial performance of the allocated memory, e.g., how quickly it was installed, how many errors were reported in associated log files, does it work seamlessly with system 50, etc. Based on an analysis of stakeholder node responses 66, performance of the cloud orchestrators and resource selection process 52 can be determined and fed back to resource selection process 52. Based on the feedback, resource selection process 52 can tune its future behavior. Furthermore, based on the feedback, it may be determined that the allocated memory is not meeting some basic performance threshold and can be replaced before more costly errors occur.

In another embodiment, subscribing system 50 may comprise a human resource system responsible for hiring individuals into an enterprise. Recruiting and hiring candidates that will have a long term positive impact remains an ongoing challenge for almost all organizations. Unfortunately, it is difficult to quantify recruitment efforts, both at the individual hire level and the organizational level.

For new hires, a formal review process is typically required before the hire is evaluated. Such a process may take several months or even more than a year before it occurs. By that time, it is generally too late to evaluate or quantify the recruitment effort implemented by the organization.

Furthermore, the prior art provides no automated way to evaluate the recruiting processes as a whole for an organization. For instance, organizations may utilize recruiters, on-line job postings, newspaper ads, etc. Previously, there was no method of automatically assessing and quantifying the effectiveness and/or impact of different recruitment efforts. The result is that organizations may be over-committing resources to certain recruitment efforts that are less effective than others.

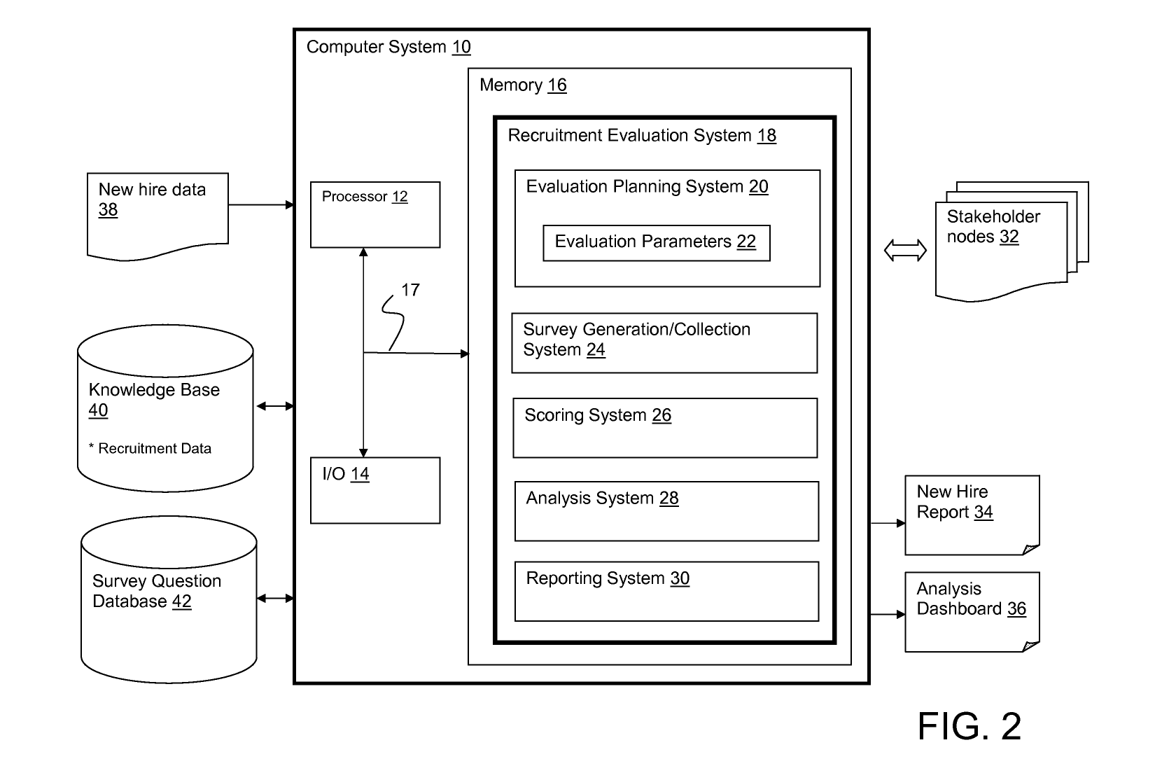

FIG. 2 depicts an evaluation platform, i.e., recruitment evaluation system 18 that measures the quality of an organization's recruitment efforts. As noted, organizations may utilize any number of tactics (i.e., recruitment efforts) to recruit new hires, including, e.g., on-line advertisements, newspapers advertisements, recruiters, referrals, websites, etc. Recruitment evaluation system 18 quantifies the quality of recruitment efforts from the individual level to the organizational level, and beyond, e.g., the industry level.

Recruitment evaluation system 18 generally includes: an evaluation planning system 20 for inputting new hire data 38; a survey generation/collection system 24 that automatically forwards survey questions to stakeholder nodes 32 and collects results; a scoring system 26 that scores a recruitment effort for each new hire entered into the system 18; an analysis system 28 that analyzes historical recruitment data from knowledge base 40 to provide comprehensive recruitment analysis, e.g., for an organization or industry; and a reporting system 30 for generating reports such as a new hire report 34 containing a score for a new hire recruitment effort or an analysis report 36 containing comprehensive recruitment analysis.

Evaluation planning system 20 may comprise any type of interface for inputting new hire data 38, either manually or automatically via some other system. New hire data 38 may include, for example: employee/candidate identity, position, hire date, work start date, evaluation period, manager, termination date (if applicable), organization unit (department, division, etc.), on-boarding stop/start dates, etc. Additional metadata associated with the new hire may include the recruitment effort utilized to recruit the hire, the date the recruitment effort began for the new hire, years of experience of the new hire, the location where new hire was from, etc. It is understood that any data associated with the new hire may be collected and stored, and the new hire data 38 described herein are for illustrative purposes and are not intended to be limiting. Once entered, the new hire data 38 may be loaded into any type of data structure, file, table, etc., referred to generally herein as a new hire record or record, that is stored in knowledge base 40 along with other previously entered new hire records. Knowledge base 40 may be accessed or processed using any type of database or computing technology, and may for example include recruitment data (source, source method, time, recruiter ID, job requisition, hiring manager, performance data, employee engagement data, recruitment/on-boarding feedback data, industry comparative data, benchmark data, etc.

In addition to the new hire data 38, evaluation parameters 22 are determined, including, e.g., an evaluation period, stakeholder node IDs, relationship of the new hire to the stakeholders, custom questions, report recipients and format, etc. The evaluation period is set either by the organization or by some automated process. The evaluation period dictates when the recruitment effort associated with a new hire should be evaluated. As noted, a concept of the present approach relies on the fact that the success of a particular recruitment effort should be determined within a reasonably short period (e.g., 90-180 days or less) after the new hire begins employment. After such a period, the success or failure of the new hire within the organization will be more and more influenced by other factors, such as the employee's manager, trainers, performance of the business, etc. Accordingly, quantifying the effectiveness of a particular recruitment effort should be determined within such a reasonably short period so as to minimize these other influences.

After completion of the evaluation period, survey generation/collection system 24 will send out (e.g., via email or other delivery system) a questionnaire comprising a set of survey questions to a set of stakeholder nodes 32 regarding the new hire. Stakeholder nodes 32 may for example be identified when the new hire data 38 is inputted, or any time thereafter. In general, stakeholder nodes 32 may include any system, process, email address, ID, etc., of a process or person associated with the new hire, and having knowledge of the new hire within the organization, e.g., the new hire's manager, one or more co-workers, the new hire him or herself, on-line testing and training systems, log files, computer records, email accounts, phone records, etc.

Survey generation/collection system 24 may automatically select and package a questionnaire or inquiry from a survey question database 42 based on various criteria. For example, survey questions may be predicated on the position of the new hire, e.g., survey questions for a VP of Sales may be different than survey questions for an entry level programmer. Additionally, survey questions may differ based on the stakeholder 32, e.g., a manager may receive different questions versus a co-worker, etc. In general, survey questions will query topics such as: (1) how well the new hire is doing with training; (2) how well the new hire fits in with the culture; (3) whether the new hire is meeting specific performance metrics associated with the position; etc.

Once the results of the survey questions are collected by survey generation/collection system 24, scoring system 26 generates a recruitment score for the recruitment effort. The recruitment score may comprise a pure score, e.g., on a scale of 1-10, and/or a comparative score, e.g., relative to other recruitment efforts already done by the organization. The pure score would give some basic feedback regarding the recruitment effort. For example, the organization may strive to have recruitment efforts score above a 7.5 out of 10. If a recruitment effort falls below such a threshold, the organization may consider not using that particular recruitment effort in the future. Furthermore, a low score may also be utilized by the organization to indicate some issue with the new hire that requires intervention, e.g., the new hire requires more training, is a bad fit, etc. Often, organizations will not be able to spot problems with a new hire issue for many months after the hiring date unless an early formal review process is in place. The recruitment score thus provides an automated process for achieving both an evaluation of the recruitment effort and an early evaluation of the new hire.

The generated recruitment score may be calculated in any fashion. For example, survey questions may be given to stakeholders requesting responses along a Likert scale (i.e., strong agree, agree, neutral, disagree, strongly disagree). Numerical values could be assigned to each response, such that, e.g., strongly agree=5, agree=4, etc. Responses from all stakeholder nodes 32 may be weighted, totaled, averaged, combined, and normalized along a scale to provide a final score. Weightings may be adjusted over time, e.g., based on long term success and failure rates of hires. For instance, in a particular organization, responses from managers may be weighted greater than responses from the new hire and co-workers. After a period of time, it may be determined based on ongoing collected data that co-worker responses provide the best measure of new hire success and should be weighted higher than managers.

Comparative scores allow the organization to rate the recruitment effort relative to other previous recruitment efforts (stored in knowledge base 40). For instance, the comparative scores may indicate that the recruitment effort was in the top 10^{th} percentile of all recruitment efforts within the organization. Different types of comparative scores may be provided, e.g., relative to other recruitment efforts in the same business unit, relative to other recruitment efforts involving recruiters, relative to other recruitment efforts for hires in a geographic region, etc.

Reporting system 30 may provide any type of interface to generate reports, including a new hire report 34. For example, dropdown menu selections may be provided to allow a user to customize a report, e.g., provide a report that shows the pure recruitment score for the new hire, as well as a comparative score relative to the organization as a whole.

Analysis system 28 provide a more detailed recruitment assessment by performing statistical analysis and data mining of information in knowledge base 40 collected over time. For example, analysis system 28 may be implemented to rank all of the recruitment efforts in an organization or industry based any single criteria. For instance, an organization ranking of recruitment efforts may be as follows:

| Recruitment effort | Average Score |
|---|---|
| Recruiters | 8.8 |
| Newspaper ads | 8.6 |
| On-line advertising | 7.9 |
| Referrals | 7.5 |
| Website | 6.6 |

Furthermore, analysis system 28 may be implemented to evaluate recruitment data on a more granular data, e.g., ranking individual on-line resources, such as:

| On-line Recruitment Effort | Average Score |
|---|---|
| Monster ® | 8.2 |
| Career Builder ® | 7.9 |
| LinkedIn ® | 7.7 |

Analysis system 28 can also evaluate recruitment data based on multiple variables. For example, analysis system 28 could generate a list of the best recruitment efforts for recruiting: (a) a Sales Manager (b) for a manufacturing company (c) in the Southeast US. In another example, analysis system 28 could determine (a) the best months (b) to use on-line resources (c) for hiring web designers, etc. Obtaining such results may for example be done via reporting system 30, e.g., with SQL queries against recruitment data in knowledge base 40, via dropdown menus, or using other known database reporting techniques.

In a further embodiment, analysis system 28 may utilize clustering or other such statistical analysis techniques to identify and exploit key factors, such as circumstances under which different recruitment effort is most effective. For example, recruitment data for each new hire in knowledge base 40 may be processed using k-means clustering. In this case, each new hire record would be treated as an observation in the form of a d-dimensional real vector, such as:

<new hire ID> = 1234

<industry> = manufacturing
<organization> = ABC Corp
<business unit> = 4
<position> = sales manager
<years of experience> = 8.5
<location> = 10001
<hiring manager ID> = 4321
<hiring date> = 04//15/14
<evaluation period> = 90
<recruitment effort> = recruiter_joe.smith
<survey score> = 8.7

The above vector details an illustrative set of information (i.e., record) collected by knowledge base 40 for each new hire. Given a set of such records (observations), k-means clustering aims to partition the n observations into k (≦n) sets S={S₁, S₂, . . . , Sₖ} so as to minimize the within-cluster sum of squares (WCSS). In other words, its objective is to find:

$${argmin}_{S} {\sum }_{i = 1}^{k} {\sum }_{{x}_{j} ∈ {S}_{i}} {‖ {x}_{j} - {μ}_{i} ‖}^{2}$$

where μᵢ is the mean of points in Sᵢ. In one illustrative embodiment, Lloyd's algorithm may be utilized to find k number of partitions. Other types of clustering could also be utilized to generate similar results, e.g., centroid-based clustering, EM clustering, etc.

Using clustering, analysis system 28 may for example determine circumstances under which different types of recruitment efforts work best. For example, based on clustering, it may be determined that on-line recruitment efforts provide the best results for non-managerial positions; that new hires recruited from the west coast have the best recruitment scores when a recruiter is utilized; newspaper ads generate the best results when recruiting educational positions in the Midwest, etc.

Irrespective of the type of analysis used, reporting system 30 can be configured to generate an analysis report 36 comprising a recruitment assessment based on inputs or requirements of an end user. Based on the analysis report 36, the system 18 will be able to make effective decisions regarding recruitment resources to deploy in the future.

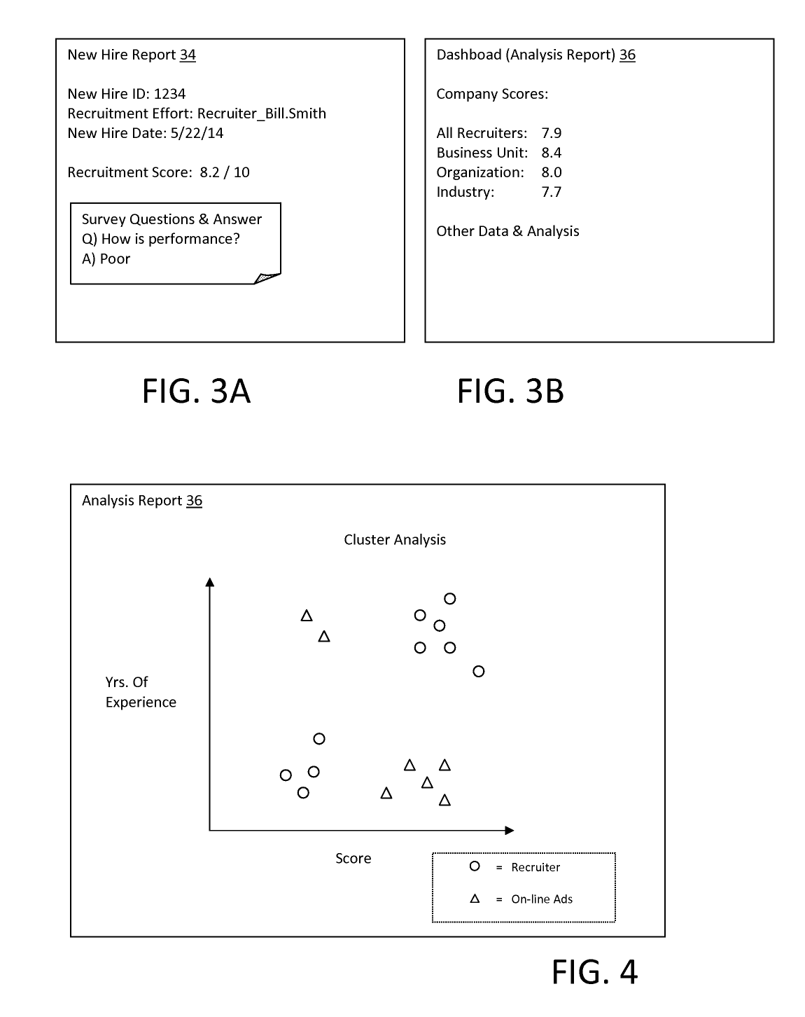

FIG. 3A depicts an illustrative new hire report 34. As shown, the recruitment effort for the new hire consisted of a recruiter (Bill Smith), and yielded a recruitment score (i.e., performance measure) of 8.2. In addition to the recruitment score, additional information for the hire, e.g., survey questions and answers, etc., can be provided.

FIG. 3B depicts a dashboard of an analysis report 36 that shows an overall assessment of the hiring process. In this example, various comparative scores are shown, including: average scores for all recruiters, scores for a business unit, for the organization itself, and for the industry as a whole. Other data and analysis may be included including, e.g., new employee feedback, hiring manager analysis, recruiter analysis, source analysis, cluster analysis, trends, organization wide engagement, etc.

FIG. 4 depicts a further illustrative analysis report 36 that includes a cluster analysis assessment for all recruiters and on-line ads based on years of experience of the person being recruited. As can be seen, four resulting clusters or factors are identifiable that indicate that recruiters score higher for recruits having more experience and lower for recruits having less experience. Conversely, on-line ads score higher for recruits with less experience and lower for recruits having more experience. A clustering algorithm, as described herein, could be implemented to automatically identify such clusters. It is understood that the assessment shown in FIG. 4 is intended to portray one of any number of possible outcomes from statistically analyzing the recruitment data.

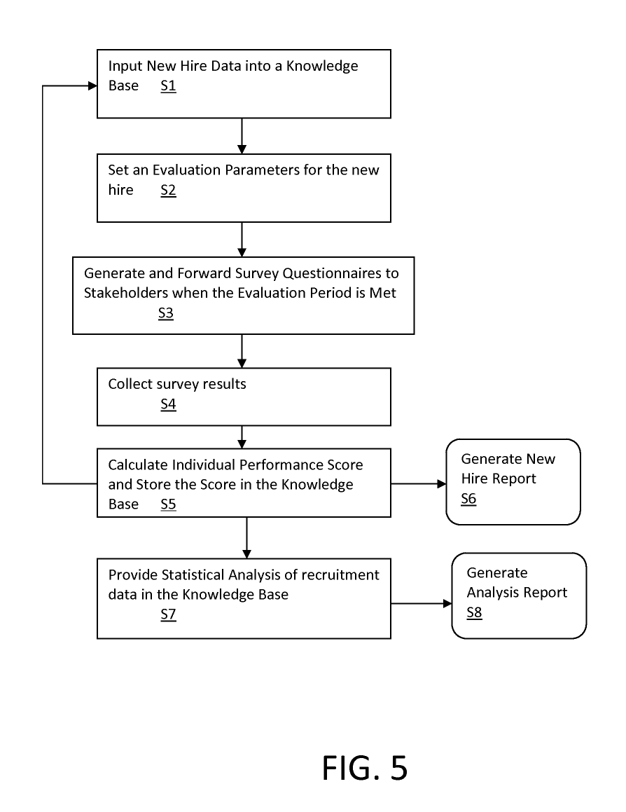

FIG. 5 depicts a flow diagram showing a method of implementing recruitment evaluation system 18. At S1, new hire data is inputted into a knowledge base 40 and at S2, an evaluation parameters are set for the new hire, including an evaluation period (e.g., 90 days). At S3, survey questionnaires are generated and forwarded to stakeholder nodes, e.g., via a network, when the evaluation period is met and at S4 the survey results are collected.

At S5, a individual performance (i.e., recruitment) score is calculated and stored in the knowledge base 40 along with the new hire data, and at S6 a new hire report is generated. The process S1-S5 loops for each new hire, e.g., employed by the organization or an organization utilizing the recruitment evaluation system 18. After a statistically significant number of new hires are entered into the knowledge base 40, a statistical analysis can be provided at S7, such as a cluster report or the like, and at S8 an analysis report is generated.

The present invention may be implemented as a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Python, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

FIG. 2 depicts an illustrative computer system 10 that may comprise any type of computing device and, and for example includes at least one processor 12, memory 16, an input/output (I/O) 14 (e.g., one or more I/O interfaces and/or devices), and a communications pathway 17. In general, processor(s) 12 execute program code, such as recruitment evaluation system 18, which is at least partially fixed in memory 16. While executing program code, processor(s) 12 can process data, which can result in reading and/or writing transformed data from/to memory 16 and/or I/O 14 for further processing. Pathway 17 provides a communications link between each of the components in computer system 10. I/O 14 can comprise one or more human I/O devices, which enable a user to interact with computer system 10. To this extent, recruitment evaluation system 14 can manage a set of interfaces (e.g., graphical user interfaces, application program interfaces, etc.) that enable humans and/or other systems to interact with the recruitment evaluation system 18. Further, recruitment evaluation system 14 can manage (e.g., store, retrieve, create, manipulate, organize, present, etc.) data using any solution.

For the purposes of this disclosure, the term database or knowledge base may include any system capable of storing data including tables, data structure, XML files, etc.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A computing platform for evaluating performance of nodes external to a subscribing system, comprising:
a system for capturing metadata associated with a new resource in response to the new resource being introduced into the subscribing system from an external node, wherein the metadata includes details about the external node and the new resource;
a system for interrogating a plurality of stakeholder nodes in the subscribing system regarding interactions with the new resource after a predetermined evaluation period has ended; and
a system for analyzing response data from the plurality of stakeholder nodes, wherein an analysis of the response data is used to calculate a measured performance of the external node.

2. The computing platform of claim 1, wherein the measured performance of the external node includes comparisons to past performance of other external nodes.

3. The computing platform of claim 1, wherein the external nodes comprise cloud orchestrators that broker computing resources.

4. The computing platform of claim 1, wherein the external nodes broker human resources.

5. The computing platform of claim 1, wherein the subscribing system includes a resource selection system, and wherein the measured performance is fed back into the resource selection system to tune future resource selections.

6. The computing platform of claim 1, wherein the resource node includes a new hire, the metadata includes human resource and recruitment data, the interrogating includes a set of survey questions, and the measured performance includes a performance measure of a recruiter.

7. A computer program product stored on computer readable medium, which when executed by a computer system, evaluates performance of a resource selection process in a subscribing system, comprising:
program code for inputting metadata into a knowledge base for a new resource and assigning an evaluation period for the new resource;
program code for automatically distributing inquiries to stakeholder nodes after completion of the evaluation period via a network and collecting results via the network;
program code that evaluates the results and assigns a performance measure to the resource selection process associated with the new resource;
program code that statistically analyzes resource selection data of a plurality of new resources and generates a resource selection assessment; and
program code for outputting at least one of the performance measure and the resource selection assessment in response to an inputted requirement.

8. The computer program product of claim 7, wherein the results are collected using email.

9. The computer program product of claim 7, wherein the inquiries comprise survey questions requesting a scaled response.

10. The computer program product of claim 7, wherein the new resource comprises a human resource and the inquiries include:
at least one question directed at new hire training;
at least one question directed at cultural fit; and
at least one question directed at job performance.

11. The computer program product of claim 7, wherein the results are translated into numerical values, weighted, and combined into the performance measure.

12. The computer program product of claim 7, wherein the performance measure includes a recruitment score that comprises a comparative score that rates recruitment efforts relative to at least one of: an organization, an industry, and a set of related recruitment efforts.

13. The computer program product of claim 7, wherein the analysis utilizes a clustering algorithm to identify factors that impact effectiveness of the resource selection process.

14. A computerized method of evaluating performance of a resource selection process in a subscribing system, comprising:
inputting metadata for a new resource into a knowledge base in response to the new resource being introduced into the subscribing system and assigning an evaluation period for the new resource;
automatically distributing inquiries after completion of the evaluation period via a network to a set of stakeholder nodes and collecting results via the network;
evaluating the results and assigning a performance measure to the resource selection process associated with the new resource;
statistically analyzing resource selection data of a plurality of new resources and generating a resource selection assessment; and
outputting at least one of the performance measure and the resource selection assessment in response to an inputted requirement.

15. The computerized method of claim 14, wherein the inquiries collect scaled responses.

16. The computerized method of claim 14, wherein the inquiries comprise a questionnaire that includes:
at least one question directed at new hire training;
at least one question directed at cultural fit; and
at least one question directed at job performance.

17. The computerized method of claim 14, wherein results from the inquiries are translated into numerical values, weighted, and combined into the performance measure.

18. The computerized method of claim 14, wherein the performance measure comprises a comparative score that rates the resource selection process relative to at least one of: an organization, an industry, and a set of related resource selection efforts.

19. The computerized method of claim 14, wherein the analysis utilizes a clustering algorithm to identify factors that impact effectiveness of resource selection process.

20. A system for evaluating recruitment efforts, comprising:
a system for inputting recruitment data for a new hire data into a knowledge base and assigning an evaluation period for the new hire;
a system for automatically distributing questionnaires comprising survey questions after completion of the evaluation period via a network to a set of stakeholders and collecting survey results via the network;
a scoring system that evaluates the survey results and assigns a recruitment score to a recruitment effort associated with the new hire;
an analysis system that statistically analyzes recruitment data of a plurality of new hires and generates a recruitment effort assessment; and
a reporting system for outputting at least one of the recruitment score and the recruitment effort assessment in response to an inputted requirement.
